(19) United States
(12) Patent Application Publication
(10) Pub. No.: US 2025/0037346 A1
(43) Pub. Date: Jan. 30, 2025

(54) MODELING OF THE LIPS BASED ON 2D AND 3D IMAGES

(71) Applicant: L'Oreal, Paris (FR)

(72) Inventors: Grégoire Charraud, Paris (FR); Matthieu Jacob, Paris (FR)

(73) Assignee: L'Oreal, Paris (FR)

(21) Appl. No.: 18/715,151

(22) PCT Filed: Nov. 15, 2022
(86) PCT No.: PCT/EP2022/081990

§ 371 Date: May 31, 2024

(30) Foreign Application Priority Data
Dec. 3, 2021 (FR) FR2112890

(51) Int. Cl. G06T 15/00; G06T 7/50; G06V 10/46

(52) U.S. Cl. CPC G06T 15/00; G06T 7/50; G06V 10/46; G06V 2201/07

(57) ABSTRACT

The invention relates to a method for manufacturing a personalized applicator for applying a cosmetic composition to the lips, this applicator comprising an application surface made of a material that may become laden with composition, the method comprising the following steps: (iv) Capturing an input 2D image provided with a first dimensional reference frame, (v) Capturing an input 3D image provided with a second dimensional reference frame.

The present invention relates to methods for manufacturing a personalized applicator for applying a cosmetic composition to the lips. The invention also relates to the personalized applicators thus manufactured and to cosmetic treatment, in particular make-up, methods that use them.

More generally, a cosmetic product is a product as defined in EC Regulation No. 1223/2009 of the European Parliament and of the Council of 30 Nov. 2009 on cosmetic products.

### TECHNOLOGICAL BACKGROUND

In order to apply make-up to the lips, the usual method is to apply a film of covering and/or coloring composition using an applicator such as a lip brush or a stick of lipstick, which is moved along the lips in order to cover the surface thereof. The user is able to see the effect obtained, but may be unsatisfied with the result. In particular, if they believe that the shape of their lips do not suit them, the user remains disappointed with the result. This is what happens with people who, for example, consider their lips to be too thin, too wide, asymmetric or badly proportioned with respect to the shape of their face.

Users generally desire a clean lip make-up look, yet at the same time prefer to use a stick of lipstick. Unfortunately, the latter is ill suited to the creation of clean error-free contours, and the use of a pencil is not always easy especially when not wishing to follow the natural contour of the lips.

Documents FR 752 860, U.S. Pat. Nos. 2,279,781, 2,207,959, FR 663 805, U.S. Pat. Nos. 2,412,073, 3,308,837, 2,735,435, 1,556,744, 2,248,533, 2,416,029, 1,944,691, 1,782,911, 2,554,965, 2,199,720, WO 2008/013608, US 2003/209254 and US 2010/0322693 describe how to produce an applicator the application surface of which has the predetermined shape of a mouth. This solution makes it possible to create a standard make-up look but is somewhat unsatisfactory because it does not always conform to the three-dimensional morphology of the lips and therefore leaves regions uncovered.

Other solutions have been described in applications WO 2013/045332, FR 2 980 345, WO 2013/092726, and FR 2 984 699 for producing an applicator adapted to the individual morphology of the lips. In order to achieve this, an impression of the lips of the user is produced from a record of the contour of the lips corrected generically, and then a countermold is produced, which will be used as an applicator. The user places the product in the countermold, before applying to the lips. Another option is to deliver the product through the countermold, via a multitude of holes. This solution constitutes progress, particularly as regards the cleanness and speed of application, but does not allow ideal make-up application and the applicator does not conform sufficiently to the three-dimensional morphology of the lips.

Neither do these solutions allow the applicator to be made available to the user very quickly.

To rectify these drawbacks, patent application EP3697257A1, filed by the applicant, describes a method for manufacturing a personalized applicator for applying a cosmetic composition to the lips, comprising carrying out an input 3D scan of the topography of part of the surface of the lips, and manufacturing the applicator by machining a preform or through additive manufacturing based on the scan. This document also discloses estimating the natural contour of the lips based on an image thereof, without specifying whether an input 2D image or a complementary input 3D image is involved. In any case, it does not describe either employing a first input 2D image provided with a first dimensional reference frame, or employing a second input 2D image provided with a second dimensional reference frame.

The article “3D Shape Estimation from 2D Landmarks: A Convex Relaxation Approach”, In Proceedings of CVPR 2015, Xiaowei Zhou, Spyridon Leonardos, Xiaoyan Hu, Kostas Daniilidis, Computer Vision and Pattern Recognition, studies the problem of estimating the 3D shape of an object, given a set of 2D landmarks in a single image. The developed method is applied to estimating the shape of a human pose (whole body of a standing person) and to that of the shape of a car. The disclosed method is based on examining an input 2D photo of the person or of the car, said photo being provided with a reference frame. An output 3D shape is estimated based on a convex formulation resulting from the input 2D photo and an algorithm for solving the complex problem. However, this article does not make provision for 3D modeling of the lips or to produce an applicator for the lips. It furthermore discloses a relatively complex algorithm dedicated to the views under study, based on a convex program. Finally, it does not disclose studying landmarks based on the input 3D image.

In the particular case of the lips, one major problem lies in the fact that:

The 2D image of the lips is necessarily imperfect, since said image depends on the light when capturing the image, the viewing angle, make-up, the state of the surface of the lips attached in particular to a roughness or a relief. Therefore, it is not possible, from an input 2D image alone, to extract reliable dimensions able to be used to produce a personalized applicator perfectly suited to the lips of a user.

The same applies for an input 3D image of the lips, the result of which depends on the relief of the skin, light, the exact positioning of the person, expressions on their face or their mimics, movement, even imperceptible movement, of the muscles of the face, including those of the lips, while capturing the image. As a result, dimensions extrapolated from a 3D scan will also necessarily lack preciseness, and this means that it is not possible, from this 3D image alone, to extract dimensions that are actually reliable and able to be used to produce a personalized applicator perfectly suited to the lips of a user.

The problem addressed by the invention is that of proposing a method for modeling the lips and manufacturing a personalized make-up applicator that is a reliable method, that is to say provides a model of the lips that is more conformal and precise than existing models, in order to produce an applicator that is perfectly personalized, and to do so despite the context specifically linked to the lips, which are moving parts of a person, including imperceptible movements or expressions that are sometimes involuntary.

In addition, the method should be simple, both in terms of its input parameters and in terms of the algorithm employed to analyze and utilize the input parameters.

### DEFINITION OF THE INVENTION

The invention relates to a method for manufacturing a personalized applicator for applying a cosmetic composition to the lips, this applicator comprising an application surface made of a material that may become laden with composition, characterized in that the method comprises the following steps:

Capturing an input 2D image, provided with a first dimensional reference frame, of at least part of the surface of the lips,

Capturing an input 3D image, provided with a second dimensional reference frame, of the at least part of the surface of the lips, and

Producing, at least from the input 2D image, provided with the first dimensional reference frame, and from the input 3D image, provided with the second dimensional reference frame, at least part of the applicator or of a mold used to manufacture it, by machining a preform or through additive manufacture.

The method comprises determining at least one landmark visible both in the input 2D image and in the input 3D image and assigning this landmark a dimensional coordinate in an output 3D image.

The method according to the invention uses an input 2D image provided with a dimensional marker and an input 3D image provided with a dimensional marker. By virtue of these two two-dimensional markers, it becomes possible to improve the dimensional precision of the applicator or of the mold used to manufacture it, and to get as close as possible to the actual dimensions of the lips of the person.

The applicator resulting from the method according to the invention is truer and conforms better to the lips than those from the prior art. The applicator is thus better personalized, for better make-up application.

The invention makes it possible to achieve a professional-quality make-up look oneself, on a surface of the lips, by virtue of a morphological applicator tailor-made to suit the user.

The personalized applicator according to the invention in particular makes it possible to define the mouth perfectly, and to color it evenly, if desired.

The invention also relates to a method for applying make-up to the lips, comprising applying a cosmetic composition to the lips using an applicator obtained using the method described above.

The invention makes it possible to offer a make-up result with a clean contour, improving the harmony of the face. The invention also offers a way of applying make-up very quickly, in a single gesture, and anywhere, even without a mirror, for example in the car or at the office.

The invention allows make-up to be applied in bright colors and/or using a long-lasting composition without risk, even on a daily basis because the personalized applicator makes it possible to avoid the failures that occur when this type of product is applied using known applicators.

The personalized applicator according to the invention makes it possible to redefine the contour of the lips, providing a remodeling effect, and may therefore be used by people whose contour has become indefinite, notably as a result of the ageing of skin, and who no longer dare to apply make-up.

The invention also relates to a method for the computerized modeling of at least one area of the lips, the method comprising the following operations:

Capturing an input 2D image, provided with a first dimensional reference frame, of at least part of the surface of the lips,

Capturing an input 3D image, provided with a second dimensional reference frame, of the at least part of the surface of the lips, and

Generating an output 3D image of the area of the lips from the input 2D image and from the input 3D image, the contour of the lips.

Another subject of the invention relates to a system for the computerized 3D modeling of at least one area of the lips, preferably intended to be used in the manufacture of a personalized applicator for applying a cosmetic product to the lips as defined above, the system comprising at least one mobile 2D and 3D image-capturing device, in particular a smartphone, in which system, once the mobile image-capturing device has been placed in a predetermined position with respect to the lips, the mobile image-capturing device is able to capture an input 2D image, provided with a first dimensional reference frame, of at least part of the surface of the lips, and to capture an input 3D image, provided with a second dimensional reference frame, of the at least part of the surface of the lips, the system furthermore comprising a processor able to generate an output 3D image of the area of the lips from the input 2D image and from the input 3D image, by determining the contour of the lips in the output 3D image based on the input 2D image.

Yet another subject of the invention relates to a personalized applicator for applying a cosmetic composition to the lips, able to be obtained using the method described above. This applicator differs from existing applicators in terms of its degree of precision in complementing the lips, by matching the surface of the lips better with a high degree of precision.

### Input 2D Image

A smartphone is preferably used as input 2D image-capturing device.

Said mobile image-capturing device is preferably placed on the same plane as the area to be measured, in particular vertically and under the user's chin in order to measure an area of their face, in particular to record the dimensions of their lips.

Information about the positioning of the mobile image-capturing device with respect to the area to be measured may be provided, in particular using a position sensor, in particular an accelerometer or a gyroscope.

The image is preferably captured automatically by the mobile image-capturing device once said predetermined position with respect to the area to be measured is reached.

One or more signals, in particular voice signals, may be sent to the user to help them place the mobile image-capturing device in said predetermined position with respect to the area to be measured and/or with respect to the mirror. It is thus possible to give the user electronic guidance.

### Reworked Surface

A “reworked surface” is understood to mean a surface the shape and/or contour of which has been modified by comparison with the natural surface the topography of which was acquired.

The method according to the invention may thus comprise a step of generating a reworked 3D surface from the data derived from the acquisition of the topography of the surface, in particular using image processing software.

In particular, it is possible to generate a reworked 3D surface by stretching the contour of the lips as obtained from the input 2D image. The input 2D image may be reworked.

The reworked surface may potentially diverge from the natural surface of the lips inside the contour thereof, in order to leave a space between the application surface and the scanned lips when the applicator is applied to the lips in the normal way. This space may serve to accommodate a self-expanding composition as will be detailed later on.

The reworked surface may coincide with the natural surface of the lips resulting from the scan, except for its contour, which differs from the natural contour of the scanned lips, in order to modify the contour of the made-up lips.

The method according to the invention may comprise a step of giving the user the option to choose between at least two make-up results, the reworked surface being generated at least on the basis of this choice, for example automatically using software.

The method according to the invention may comprise the step of allowing a user to model a surface obtained from the input 2D image, in particular the contour thereof, and thus generate the reworked surface. The modeling may be performed remotely using software from a workstation to which data representative of the 3D image have been transmitted over a telecommunications network, in particular over the Internet or by GSM/GPRS. This remote workstation is for example that of a make-up artist.

### Input 3D Image

To produce an input 3D image, it is possible to use any 3D scanner capable of capturing the volume and the dimensions of the area in question. Preferably, use is made of a 3D scanner capable also of capturing the color and appearance of the area in question, so as to acquire one or more images providing information as to the location of the composition.

The input 3D scan is advantageously a scan produced by projecting fringes of light, but any other structured light is possible.

The input 3D image may be acquired using the camera of a mobile telephone (smartphone).

However, the invention is not limited to any particular type of mobile image-capturing device.

The mobile image-capturing device, in particular in the case of a smartphone, may comprise one or more microprocessors or microcontrollers and additional circuits designed to execute an application intended to carry out the steps of the method according to the invention.

The detected landmarks and/or the measured dimensions are advantageously stored in the mobile image-capturing device and/or transmitted to a remote workstation, connected to the mobile image-capturing device, in order to manufacture a personalized applicator. This allows fast and reliable manufacture.

A specific pattern may be displayed on the screen of the mobile image-capturing device, in the form of specific forms or displays similar to QR codes, during the image acquisition in order to increase the robustness of the screen detection. With said specific pattern having to be detected in full, an error message may appear to instruct the user to carry out the acquisition again under better conditions, in particular in the case of light reflecting from the screen of said mobile image-capturing device, in particular partially masking the specific pattern.

In the case of the lips, the possible measured dimensions may be the length of the lips between the two extreme points, the height of the upper lip at various points along the lips, the height of the Cupid's bow, the distance between the top of the philtrum and the median line of the lip, the height of the lips at various points along the lips, the distance from the corner of the lips to various points along the lips and/or the height of the commissure from the highest point of the lips.

According to the invention, the input 2D image and/or the input 3D image and/or the output 3D image may be reworked.

The method according to the invention may thus comprise establishing a remote connection to a third party providing a model to propose to the person whose lips have been scanned according to the physiognomy of this person, for example using an Internet-based video-telephony platform.

The method according to the invention may comprise detecting, in particular automatically using software, asymmetry of the lips and/or the face; the reworked surface may be computed, preferably automatically, at least with consideration to the detected asymmetry.

### Manufacture of the Applicator

A file able to be read by a CNC machine or a 3D printer is advantageously generated and may be stored, in particular automatically, for example in the cloud or on a central server, and sent to all user access points, for example sales outlets or institutes. The file may be transmitted to the user. It is also possible to keep files that are not adopted, in order to avoid redundant testing.

A translated numerical copy of a surface, possibly a reworked surface, obtained from the 3D scan of the lips, is advantageously created, and then a smoothed volume of the applicator or of the mold between said surface and the translated copy thereof may be generated. In one variant, a smoothed volume of the applicator or of the mold is generated between said surface and a standard applicator surface, in particular one created by learning from multiple acquired surfaces.

The applicator may be produced by machining, preferably by micro-machining. Advantageously, a preform chosen, in particular automatically, from among many according to the shape that is to be obtained after machining, is machined. This makes it possible to shorten the manufacturing time. These preforms may have been made to measure, for example from various mouths, and their face that is to be machined is advantageously larger than the surface area of the natural lips. The preforms may have the verso face already formed, with or without a handle, or with or without a system for attaching a handle to it, or with or without a system to which to attach a compartment capable of containing a cosmetic product.

The invention offers, if so desired, the option of reproducing the applicator remotely, either when traveling having forgotten to bring it, or because it has been lost, or because someone wishes to share their applicator with somebody else. All that is required is to send the 3D file stored in a computer memory, or have it sent, so that a reproduction thereof may be made anywhere.

The 3D printer may be a filament printer. The 3D printer that is used may achieve a precision in z of 0.5 mm, better 0.1 mm, better still 0.03 mm.

In the case of 3D printing, the printing may be carried out onto a support or a predetermined object such as, for example, a preform with or without a handle, with or without a system for attaching a handle to it, or with or without a compartment capable of containing a cosmetic product.

Dimensional reference frame: A pair of two points or pixels at least in which the correlation between number of pixels between these two points and absolute real distance between these two points in the photographed element is known.

Landmark visible both in the input 2D image and in the input 3D image: A particular point of an element, able to be identified both in the input 2D image and in the input 3D image, allowing this point in the input image to be correlated with that in the output image. These may be the points: commissure point of the lips, inner or outer corners of the eyes.

### PREFERRED EMBODIMENTS

Preferably, the application element according to the invention has one or more of the following features, taken individually or in combination:

### Method for Manufacturing a Personalized Applicator

Said method comprises determining a plurality of points of the contour of the lips, based on the input 2D image, and estimating the contour of the lips in the output 3D image, through interpolation based on these points.

It comprises determining the depth of the lips in the output 3D image based on the input 3D image.

It comprises detecting, in the input 2D image, multiple first landmarks defining the contour of the lips and multiple second landmarks located on either side of the separating line separating the lips, in order to produce the contour of the lips in the output 3D image.

It comprises detecting, in the input 3D image, multiple third landmarks defining the commissures of the lips and multiple fourth landmarks located on the longitudinal axis X of the lips, in order to produce the depth of the lips in the output 3D image.

It comprises determining at least one landmark visible both in the input 2D image and in the input 3D image and assigning this landmark a dimensional coordinate in an output 3D image.

It comprises displaying a printable and/or manufacturable output 3D image.

It comprises information for positioning a mobile image-capturing device with respect to the area of the lips, in particular using a position sensor.

It comprises generating a reworked output 3D surface, in particular by stretching the input 2D image, the applicator or the mold used to manufacture it having a shape given at least partially by this reworked surface.

### Method for Applying Make-Up to the Lips

Said method comprises determining the contour of the lips in the output 3D image based on the input 2D image.

It comprises determining the depth of the lips in the output 3D image based on the input 3D image.

It comprises information for positioning a mobile image-capturing device with respect to the area of the lips, in particular using a position sensor, in particular an accelerometer or a gyroscope.

It comprises generating a reworked output 3D surface, in particular by stretching the input 2D image, the applicator or the mold used to manufacture it having a shape given at least partially by this reworked surface.

### DESCRIPTION OF THE FIGURES

Further features and advantages of the invention will become apparent from reading the following detailed description of non-limiting illustrative exemplary implementations thereof and from examining the appended drawing, in which:

FIG. 1 shows a set of landmarks detected in an input 2D image by analyzing the image with 2D image analysis software,

FIG. 2 shows a set of landmarks detected in an input 3D image by analyzing the image with 3D image analysis software,

FIG. 3 shows the concept of a reference frame in a 3D image,

FIG. 4 shows, based on a front-on input 2D image, the identification of landmarks relevant to modeling the lips according to the invention,

FIG. 5 shows the detail B from FIG. 2,

FIG. 6 shows the detail A from FIG. 5,

FIG. 7 is a table indicating the dimensional parameters of the lips extracted from the input 2D image and those from the input 3D image,

FIG. 8 shows the parameters of FIG. 7 computed using the 2D image analysis software,

FIG. 9 shows the parameters of FIG. 7 computed using the 3D image analysis software,

FIG. 10 illustrates one mode of implementation of the method for manufacturing a personalized applicator according to the invention.

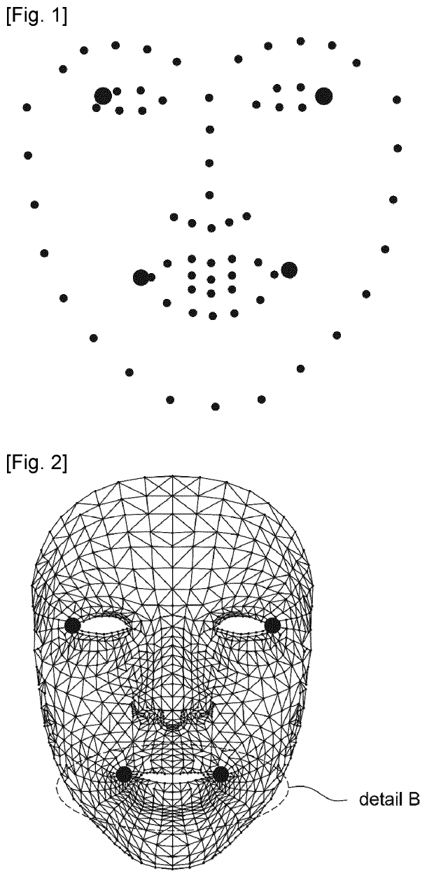

FIG. 1 shows an identification of landmarks in an input 2D image of the face, in a front-on view. The input 2D image is represented by a collection of 2D landmarks characterizing the surface to be analyzed, obtained through 2D imaging using in particular a mobile telephone. The landmarks are depicted by circles (not identified by a number), the circles being larger for landmarks located at the commissures of the lips and the eyes, also being able to be detected in the input 3D image.

FIG. 2 shows an identification of landmarks (or nodes) in a 3D image of the face, in a front-on view. The input 3D image is represented by a collection of points characterizing the surface to be analyzed, obtained through 3D imaging using in particular a mobile telephone. The largest landmarks are located at the commissures of the lips and are those also detected in the input 2D image.

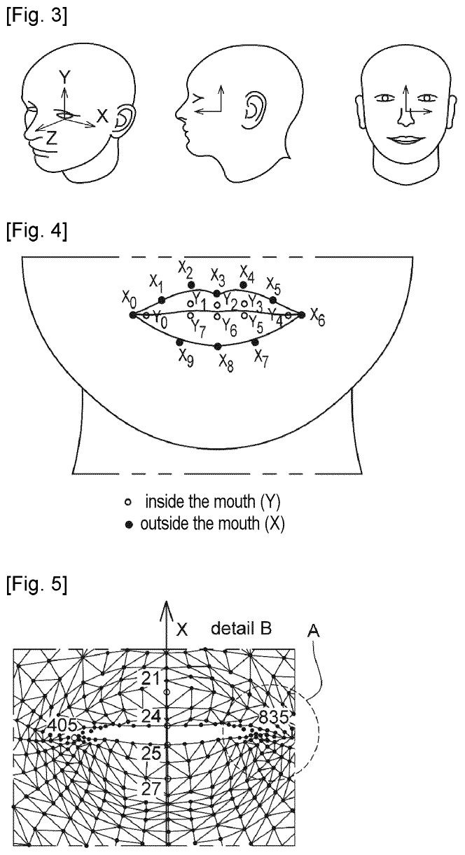

FIG. 3 shows a 3D reference frame with x, y and z axes according to the invention. It is used for each model.

FIG. 4 identifies the landmarks of an input 2D image, used to determine the contour of the lips in the output 3D image. These landmarks are the landmarks X₀, X₁, X₂, X₃, X₄, X₅, X₆, X₇, X₈, X₉ defining the contour B of the lips and multiple second landmarks Y₀, Y₁, Y₂, Y₃, Y₄, Y₅, Y₆, Y₇ located on either side of the separating line A separating the upper lip and the lower lip.

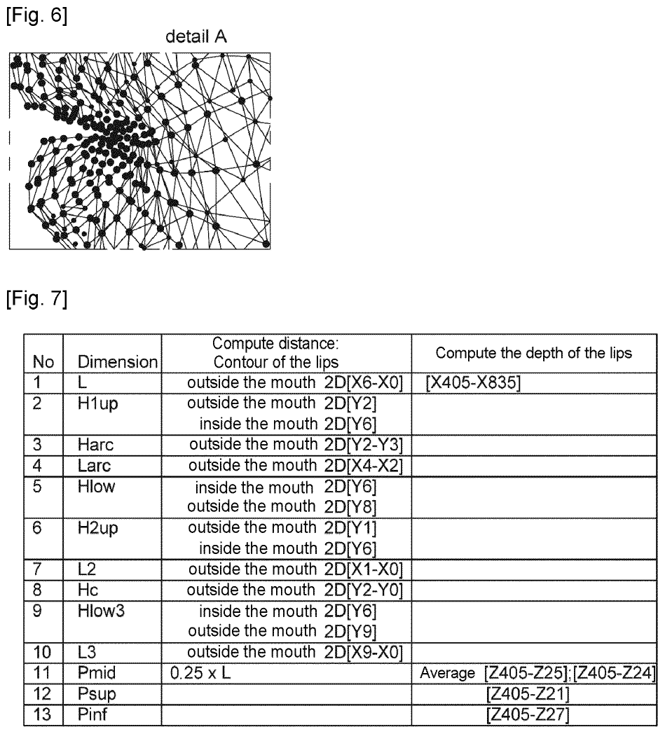

FIGS. 5 and 6 show a magnification of the area of the lips resulting from the input 3D image of FIG. 2. It is possible to see the determinant landmarks for the evaluation of the depth of the lips, namely two landmarks 405, 835 defining the commissures of the lips and four points 21, 24, 25, 27 located on the longitudinal axis X of the lips.

FIG. 7 indicates, in a table, the dimensional parameters extracted from the input 2D image and the dimensional parameters extracted from the input 3D image. The software indicated below may be used to extract these parameters:
To extract the dimensional parameters from the input 2D image shown in FIG. 4, the following software may be used: Dlib, Modiface.
To extract the dimensional parameters from the input 3D image shown in FIG. 5, the following software may be used: Truedepth from Apple, Structured light, FaceMesh.

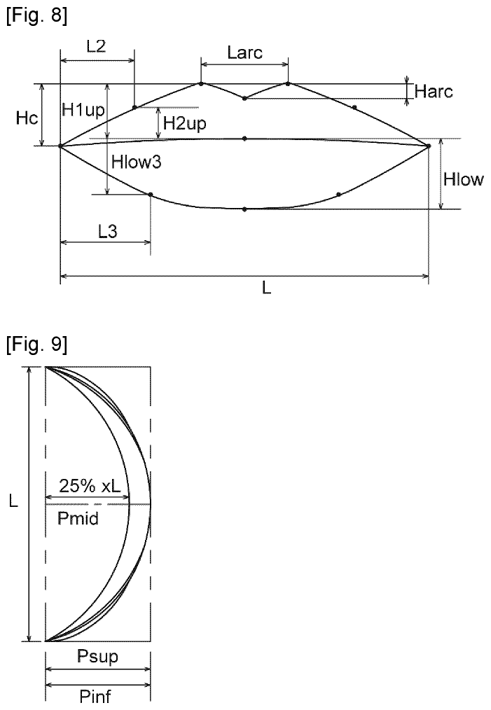

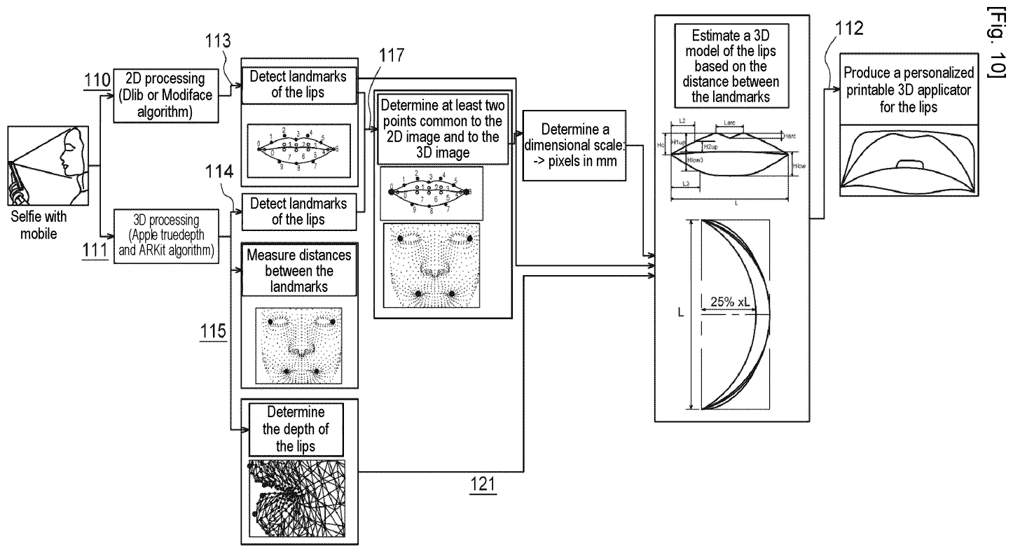

As may be seen in this table, the dimensions describing the contour of the lips, obtained using the analysis software for analyzing the input 2D image, are the dimensions L, H₁ᵤₚ, H_{arc}, L_{arc}, H_{low}, H₂ᵤₚ, L₂, H_{c}, H_{low3}, L₃. The physical meaning of each dimension is indicated in FIG. 8. The dimensions describing the depth of the lips are L, P_{mid}, Pₛᵤₚ, P_{inf}, and their physical meaning is indicated in FIG. 9. It is noted that P_{mid} is defined as being equal to 25% of L, L being defined in FIG. 8.

FIG. 10 illustrates one mode of implementation of a method for manufacturing a personalized applicator according to the invention. The method comprises capturing an image through a selfie/scan and then 2D-processing 110 and 3D-processing 111 the captured image, in order to produce 112 a personalized printable 3D applicator.

The 2D processing 110 is carried out using a Dlib algorithm, namely an open-source library of tools allowing the facial detection of sixty-eight x, y coordinates of the face, or a Modiface algorithm.

The 3D processing 111 is carried out using an Apple truedepth and ARkit algorithm, namely a library offered by Apple allowing facial recognition using Truedepth 3D capture technology.

The 2D processing 110 leads to the determination 113 of a plurality of points of the contour of the lips. The 3D processing 111 leads to the detection 114 of landmarks of the lips and to the determination 115 of the depth of the lips.

At least two points common to the 2D image and to the 3D image are detected 117, in particular in order to determine a dimensional scale. The determination of the depth of the lips with the detection of landmarks of the contour of the lips and the dimensional scale lead to the estimation of a 3D model of the lips and to the determination 121 of the dimensions of the lips.

Of course, the invention is not limited to the exemplary embodiments that have just been described.

1. A method for manufacturing a personalized applicator for applying a cosmetic composition to the lips, this applicator comprising an application surface made of a material that may become laden with composition, the method comprising the following steps:
(i) Capturing an input 2D image, provided with a first dimensional reference frame, of at least part of the surface of the lips,
(ii) Capturing an input 3D image, provided with a second dimensional reference frame, of the at least part of the surface of the lips, and
(iii) Producing (112), at least from the input 2D image, provided with the first dimensional reference frame, and from the input 3D image, provided with the second dimensional reference frame, at least part of the applicator or of a mold used to manufacture it, by machining a preform or through additive manufacture,
characterized in that it comprises determining (117) at least one landmark visible both in the input 2D image and in the input 3D image and assigning this landmark a dimensional coordinate in an output 3D image.

2. The method as claimed in claim 1, characterized in that it comprises determining (113) a plurality of points of the contour of the lips, based on the input 2D image, and estimating the contour of the lips in the output 3D image, through interpolation based on these points.

3. The method as claimed in claim 2, characterized in that it comprises determining (115) the depth of the lips in an output 3D image based on the input 3D image.

4. The method as claimed in claim 1, characterized in that it comprises detecting, in the input 2D image, multiple first landmarks (X₀, X₁, X₂, X₃, X₄, X₅, X₆, X₇, X₈, X₉) defining the contour (B) of the lips and multiple second landmarks (Y₀, Y₁, Y₂, Y₃, Y₄, Y₅, Y₆, Y₇) located on either side of the separating line (A) separating the lips, in order to produce the contour of the lips in an output 3D image.

5. The method as claimed in claim 1, characterized in that it comprises detecting (114), in the input 3D image, multiple third landmarks (405, 835) defining the commissures of the lips and multiple fourth landmarks (21, 24, 25, 27) located on the longitudinal axis (X) of the lips, in order to produce (121) the depth of the lips in an output 3D image.

6. The method as claimed in claim 1, characterized in that it comprises displaying a printable and/or manufacturable output 3D image.

7. The method as claimed in claim 1, characterized in that it comprises information for positioning a mobile image-capturing device with respect to the area of the lips, in particular using a position sensor.

8. The method as claimed in claim 1, characterized in that it comprises generating a reworked output 3D surface, in particular by stretching the input 2D image, the applicator or the mold used to manufacture it having a shape given at least partially by this reworked surface.

9. A method for applying make-up to the lips, comprising applying a cosmetic composition to the lips using an applicator obtained using the method as claimed in claim 1.

10. A method for the computerized modeling of at least one area of the lips, the method comprising the following operations:
(i) Capturing an input 2D image, provided with a first dimensional reference frame, of at least part of the surface of the lips,
(ii) Capturing an input 3D image, provided with a second dimensional reference frame, of the at least part of the surface of the lips, and
(iii) Generating an output 3D image of the area of the lips from the input 2D image and from the input 3D image, the contour of the lips.

11. The method as claimed in claim 10, characterized in that it comprises determining the contour of the lips in the output 3D image based on the input 2D image.

12. The method as claimed in claim 10, characterized in that it comprises determining the depth of the lips in the output 3D image based on the input 3D image.

13. A system for the computerized 3D modeling of at least one area of the lips, preferably intended to be used in the manufacture of a personalized applicator for applying a cosmetic product to the lips, characterized in that the system comprises at least one mobile 2D and 3D image-capturing device, in particular a smartphone, in which system, once the mobile image-capturing device has been placed in a predetermined position with respect to the lips, the mobile image-capturing device is able to capture an input 2D image, provided with a first dimensional reference frame, of at least part of the surface of the lips, and to capture an input 3D image, provided with a second dimensional reference frame, of the at least part of the surface of the lips, the system furthermore comprising a processor able to generate an output 3D image of the area of the lips from the input 2D image and from the input 3D image, by determining the contour of the lips in the output 3D image based on the input 2D image.

14. A personalized applicator for applying a cosmetic composition to the lips, characterized in that it is able to be obtained using the method as claimed in claim 1.
